(19) United States
(12) Patent Application Publication
(10) Pub. No.: US 2015/0033251 A1
(43) Pub. Date: Jan. 29, 2015

(54) NETWORK PROTOCOL FOR CONTENTS PROTECTION IN DIGITAL CABLE BROADCASTING SERVICE AND CONDITIONAL ACCESS SYSTEM USING THE PROTOCOL

(71) Applicant: Electronics and Telecommunications Research Institute, Daejeon (KR)

(72) Inventors: Han Seung KOO, Daejeon (KR); Yang Su KIM, Daejeon (KR); Dong Joon CHOI, Daejeon (KR); Nam Ho HUR, Daejeon (KR)

(21) Appl. No.: 14/340,706

(22) Filed: Jul. 25, 2014

(30) Foreign Application Priority Data
Jul. 26, 2013 (KR) 10-2013-0088416
Jun. 12, 2014 (KR) 10-2014-0071204

(51) Int. Cl. H04N 21/266; H04L 29/06

(52) U.S. Cl. CPC H04N 21/26613; H04L 63/10
USPC 725/31

(57) ABSTRACT

Disclosed are a network protocol for contents protection in a digital cable broadcasting service and a conditional access system using the protocol. A method for renewing conditional access client software (CACS) by a conditional access module in a renewable conditional access system (RCAS) may include: receiving an RCAS announcement message from a headend; transmitting to the headend a key registration request message for requesting an authorization key when the RCAS announcement message is authenticated; receiving a key registration response message including the authorization key from the headend; and generating security factors based on the authorization key and renewing the CACS by using the security factors.

This application claims the benefit of priority of Korean Patent Application No. 10-2013-0088416 filed on Jul. 26, 2013 and No. 10-2014-0071204 filed on Jun. 12, 2014, which are incorporated by reference in its entirety herein.

### BACKGROUND OF THE INVENTION

1. Field of the Invention

The present invention relates to a renewable conditional access system (RCAS) network protocol for digital cable broadcasting and a conditional access system using the protocol.

2. Discussion of the Related Art

In recent years, International Telecommunications Union Telecommunication (ITU-T) has developed a renewable conditional access system (RCAS) network protocol capable of remotely renewing conditional access client software (CACS) for digital cable broadcasting.

As one of technologies of the conditional access system, Korean Patent No. 10-0835984 “Method and Apparatus for Renewing Conditional Access System of Digital Cable Broadcasting” discloses that when a conditional access system renewal message is received from a headend, a conditional access system renewal request message is transmitted to a set-top box and when a system renewal response message is received from the set-top box, a system renewal program is received from the headend and is applied and thereafter, the applied system renewal program is notified to the set-top box and the headend.

However, a renewable conditional access system (RCAS) network protocol which is developed at present is safe in terms of safety, but complicated in implementation and operation due to complexity of a processing procedure.

### SUMMARY OF THE INVENTION

The present invention provides a network protocol that can be implemented and operated easily while safely protecting the contents upon a digital cable broadcasting service and a conditional access system using the protocol.

In accordance with an embodiment of the present invention, a method for renewing conditional access client software (CACS) by a conditional access module (CAM) included in a digital cable broadcast receiver in a renewable conditional access system (RCAS) includes: receiving an RCAS announcement message for announcing that renewal of the CACS is required from a headend; transmitting to the headend a key registration request message for requesting an authorization key for renewing the CACS when the RCAS announcement message is authenticated; receiving a key registration response message including the authorization key from the headend; and generating security factors based on the authorization key and renewing the CACS by using the security factors.

In accordance with an aspect, the method may further include, after the receiving of the RCAS announcement message, receiving from the headend an RCAS renewal message including information of a download timing of the CACS.

In accordance with another aspect, the RCAS announcement message and the RCAS renewal message may be authenticated by an RAS public key prestored in the digital cable broadcast receiver.

In accordance with yet another aspect, the RCAS announcement message may include version information of the CACS and information for the headend.

In accordance with still another aspect, the key registration request message may include a session identifier (ID), a key pairing ID, and a public key certificate of the CAM.

In accordance with still yet another aspect, the authorization key may be derived by decoding the key registration response message by using a private key of the CAM.

In accordance with still yet another aspect, the security factors may include at least one of an individual CAM client image encryption key (ICCIEK), an initial vector for the ICCIEK, a common CAM client image encryption key (CCCIEK), an initial vector for the CCCIEK, a message encryption key (MEK), an initial vector for the MEK, a message authorization key (MAK), an initial vector for the MAK, and a key pairing key (KEK).

In accordance with another embodiment of the present invention, a method for renewing conditional access client software (CACS) by a headend in a renewable conditional access system (RCAS) includes: transmitting an RCAS announcement message for announcing that renewal of the CACS is required to a conditional access module (CAM) included in a digital cable broadcast receiver; receiving a key registration request message for requesting an authorization key for renewing the CACS from the digital cable broadcast receiver; generating the authorization key and security factors based on the key registration request message; and transmitting to the CAM a key registration response message including the authorization key and transmitting renewal information for downloading the CACS.

In accordance with yet another embodiment of the present invention, a digital cable broadcast receiver of a renewable conditional access system (RCAS) includes: at least one memory; at least one processor; and a conditional access module (CAM), wherein the conditional access module receives an RCAS announcement message for announcing that renewal of conditional access client software (CACS) is required from a headend, transmits to the headend a key registration request message for requesting an authorization key for renewing the CACS when the RCAS announcement message is authenticated, receives a key registration response message including the authorization key from the headend, and generates security factors based on the authorization key and renewing the CACS by using the security factors.

In accordance with still another embodiment of the present invention, a headend of a renewable conditional access system may include a conditional access module authentication sub-system that transmits an RCAS announcement message for announcing that renewal of conditional access client software is required to a conditional access module included in a digital cable broadcast receiver, receives a key registration request message for requesting an authorization key for renewing the CACS from the CAM, and transmits the key registration request message to an authentication center when the validity of the key registration request message is verified and authentication of the key registration request message is succeeded, and the authentication center that generates the authorization key and security factors based on the key registration request message and a key registration response message including the authorization key to the CASS so as to transmit the authorization key to the CAM.

A common hash key (CHK) and an individual hash key (IHK) defined in the existing renewable conditional access system (RCAS) network protocol are not used, and as a result, complexity is removed, in which an announcement phase is unnecessarily moved to a key establishment phase meanwhile and thereafter, moved to the announcement phase again.

In the existing RCAS network protocol, the key establishment phase and a conditional access module registration phase are integrated into one phase, and as a result, the RCAS network protocol can be implemented and operated more easily.

### BRIEF DESCRIPTION OF THE DRAWINGS

FIG. 1 is a diagram illustrating a processing procedure of the existing RCAS network protocol.

FIG. 2 is a diagram illustrating a processing procedure of an RCAS network protocol according to an embodiment of the present invention.

FIG. 3 is a diagram illustrating a syntax of a key registration request message according to an embodiment of the present invention.

FIG. 4 is a diagram illustrating a syntax of a key registration response message according to an embodiment of the present invention.

FIG. 5 is a flowchart illustrating an operation of a digital cable broadcast receiver according to an embodiment of the present invention.

FIG. 6 is a flowchart illustrating an operation of a headend according to an embodiment of the present invention.

FIG. 7 is a block diagram illustrating a renewable conditional access system according to an embodiment of the present invention.

### DETAILED DESCRIPTION OF THE EMBODIMENTS

The present invention will be described more fully hereinafter with reference to the accompanying drawings, in which embodiments of the invention are shown. However, the present invention can be realized in various different forms, and is not limited to the embodiments described herein. Accordingly, the drawings and description are to be regarded as illustrative in nature and not restrictive. Like reference numerals designate like elements throughout the specification. In addition, in the specification, unless explicitly described to the contrary, the word “comprise” and variations such as “comprises” or “comprising”, will be understood to imply the inclusion of stated elements but not the exclusion of any other elements.

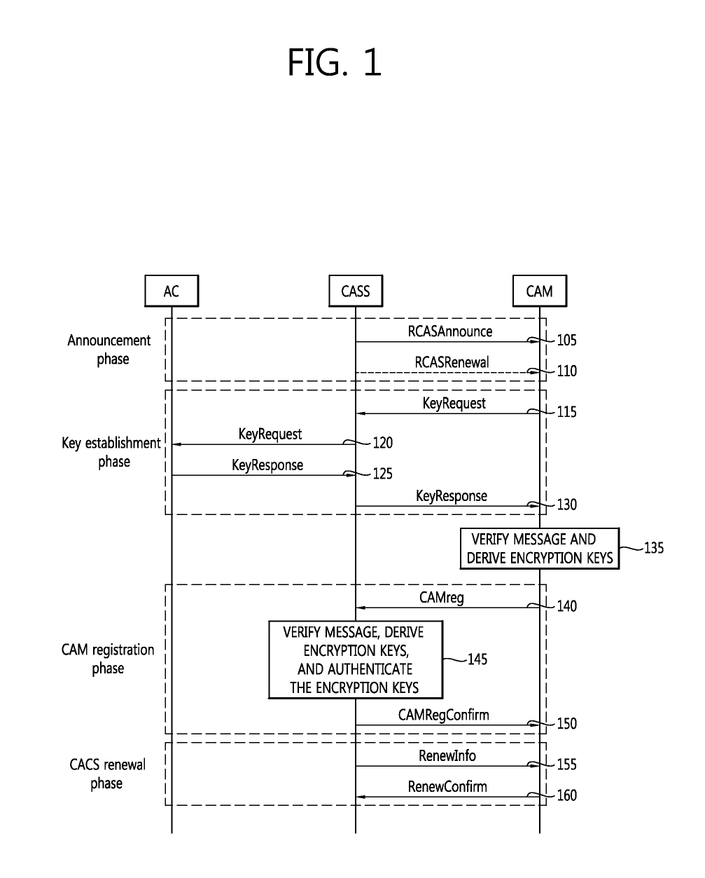

FIG. 1 is a diagram illustrating a processing procedure of the existing RCAS network protocol.

A renewable conditional access system (RCAS) includes a headend including an authentication center (AC) and a conditional access module (CAM) sub-system (CASS) and a digital cable broadcast receiver including a conditional access module (CAM).

The headend performs four phases of an authentication phase, a key establishment phase, a CAM registration phase, and a CACS renewal phase as illustrated in FIG. 1 when conditional access client software (CACS) is renewed.

In the authentication phase, the CASS controls an RCAS announcement message (RCASAnnounce) to be transmitted to the CAM (105). The RCAS announcement message may include CASS information including an identifier (ID) of the CASS, an Internet protocol (IP) address of the CASS, an IP connection type (for example, a transmission control protocol (TCP), or a user datagram protocol (UDP)), a listening port number, etc., and CAM client version information including a CAM hardware version, a CAM software version, a CACS type, etc. The CASS authenticates the RCAS announcement message by a hashed message authentication code (HMAC) scheme and transmits the authenticated RCAS announcement message to CAMs by using a multicast scheme.

The CAM authenticates the RCAS announcement message by using the common hash key (CHK) which is prestored and performs the key establishment phase when succeeding in the authentication. Accordingly, when the CHK which is prestored in the CAM and the CHK of the CASS are different from each other, when the CAM is moved to a CASS zone, or when the CAM is in a virgin state, the CAM should acquire the CHK from the key establishment phase.

Meanwhile, the headend may optionally transmit the RCAS renewal message to the respective CAMs by using the CASS (110). The RCAS renewal message is used to announce a CACS download time to the CAM or request transmitting a key request message or purchase information. For this, the RCAS renewal message may include information of a CACS image download time, a key upgrade request, a purchase information request, etc. The RCAS renewal message is authenticated by the same method as the RCAS announcement message.

In the key establishment phase, the headend receives the key request message (KeyRequest) from the CAM as a response to the RCAS announcement message by using the CASS (115). Herein, the CAM may transmit a key request message digitally signed by a private key of the CAM to the CASS. The CASS transmits the received key request message to the AC (120) and receives a key response message (KeyResponse) as a response to the key request message (125). Further, key response message is transmitted to the CAM (130).

In detail, the CASS verifies a digital signature of the key request message received from the CAM and transmits a new key request message to the AC. Herein, the new key request message is regenerated based on a key pairing identifier (ID) and a CASS identifier (ID) extracted from the key request message received from the CAM.

The AC searches a CAM certificate based on the key pairing ID and authenticates the CAM based on the CAM certificate. In addition, a key response message including a CAM authentication result is transmitted to the CASS. When the CAM is in the virgin state, the AC performs transmission protocol pairing. Alternatively, when the CAM is not in the virgin state, the AC compares received pairing information and an initial pairing value.

The CASS generates the common hash key (CHK) and the individual hash key (IHK) through a hash key generation procedure when succeeding in the CAM authentication, and generates a key response message including a CASS certificate, the CHK, and the IHK. In addition, the CASS digitally signs the generated key response message using the private key of the CASS. Thereafter, the CASS encrypts a part of the digitally signed key response message using a public key of the CAM and transmits the encrypted key response message to the CAM.

The CAM verifies validity of the key response message based on the CAM certificate and decrypts information included in the key response message to derive a public key, a private key and an encryption key (135).

In a CAM registration phase, the CAM generates a message encryption key (MEK) and an individual CAM client image encryption key (ICCIEK) and thereafter, transmits a CAM registration message (CAMreg) including the MEK and the ICCIEK to the CASS (140). The CASS verifies validity of the received CAM registration message, derives the MEK and the ICCIEK by the same method as the CAM, and compares the MEK/ICCIEK received from the CAM and an MEK/ICCIEK generated thereby to authenticate whether both MEKs/ICCIEKs are identical to each other (145). If it is judged that both MEKs/ICCIEKs are identical to each other, the CASS transmits a CAM registration confirmation message (CAMRegConfirm) to the CAM (150). In this case, the CAM registration confirmation message is authenticated by the IHK and encrypted by an advanced encryption standard (AES) algorithm.

In a CACS renewal phase, the headend controls renewal information (RenewInfo) to be transmitted to the CAM from the CASS (155). The renewal information is used to permit the CAM to download CACS image information. When the CAM receives the renewal information, the CAM performs an operation of authenticating and decrypting the renewal information. In addition, the CAM downloads the CACS image information from a server storing the CACS image information. The CACS image information is encrypted by the ICCIEK and a common CAM client image encryption key (CCCIEK), and as a result, the CAM decodes the CACS image information by using the ICCIEK and the CCCIEK. When the CACS image information is successfully decoded, the CAM transmits a renewal confirmation message (RenewConfirm) to the CASS (160).

As described above, since the existing RCAS network protocol uses the CHK and the IHK, the authentication phase is moved to a predetermined phase in the meantime to acquire a new CHK and a new IHK through the key response message and thereafter, the authentication phase needs to be performed again the CHK which is prestored in the CAM is different from the CHK of the CASS, and as a result, the implementation and the operation are complicated. Therefore, in the present invention, the following procedure may be performed upon renewing the CACS.

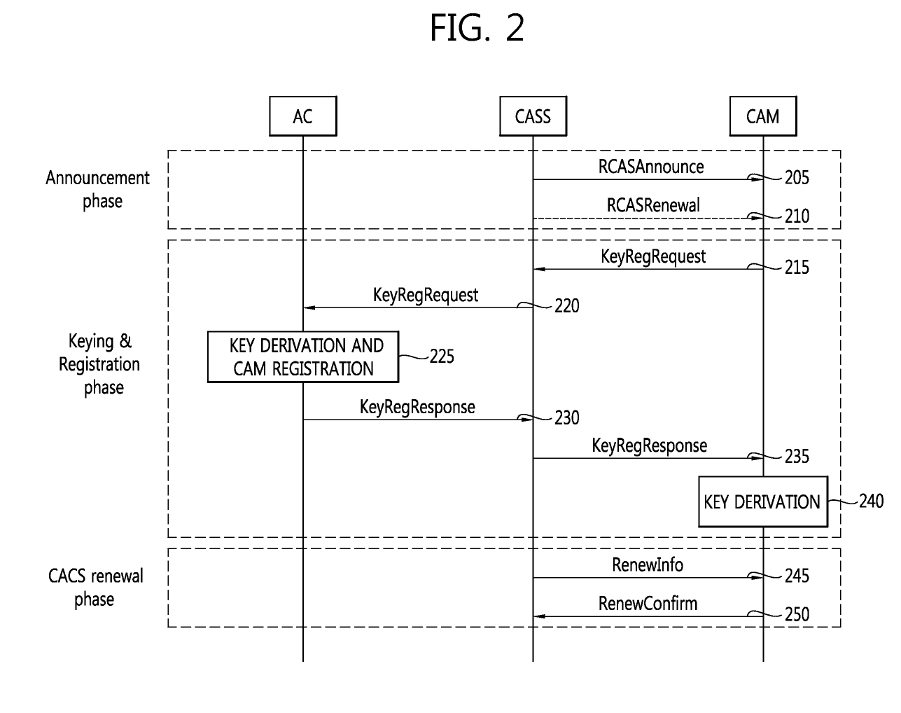

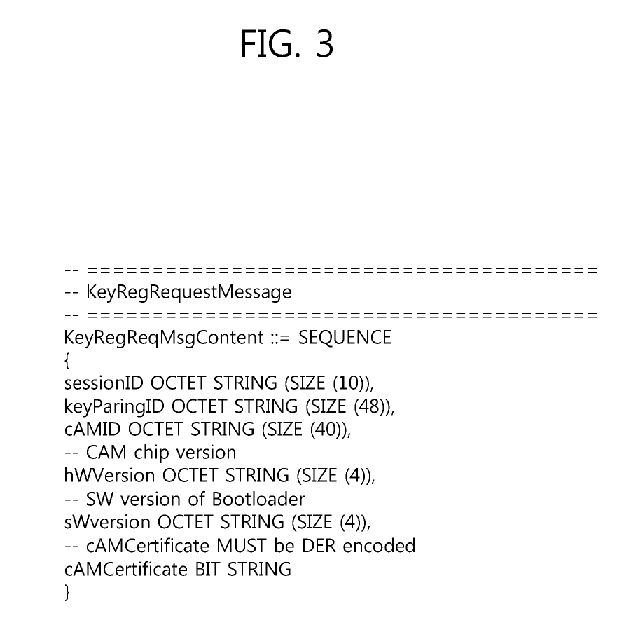

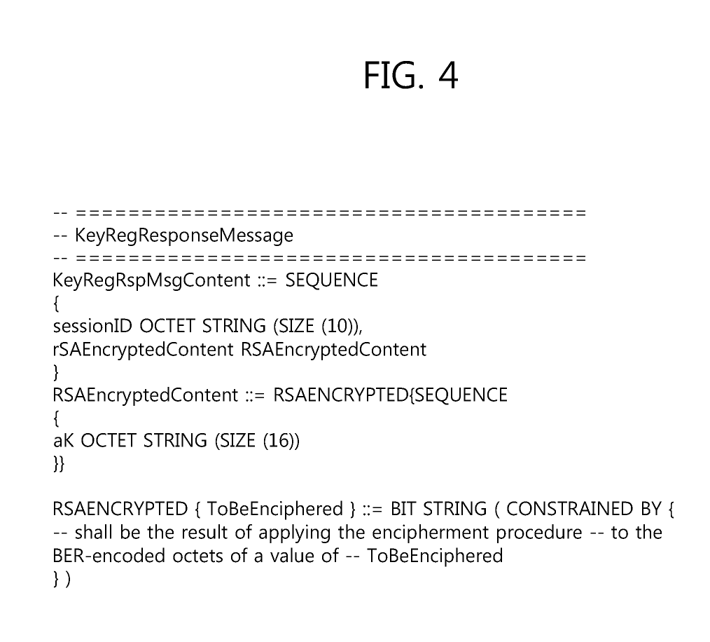

FIG. 2 is a diagram illustrating a processing procedure of an RCAS network protocol according to an embodiment of the present invention. FIG. 3 is a diagram illustrating a syntax of a key registration request message according to an embodiment of the present invention. FIG. 4 is a diagram illustrating a syntax of a key registration response message according to an embodiment of the present invention.

The RCAS network protocol according to the present invention is divided into three phases of an authentication phase, a keying & registration phase, and a CACS renewal phase.

The authentication phase is used to announce the start of the RCAS network protocol to the CAMs and announce CASS access information when renewal of the CACS is required. In the authentication phase, the CASS transmits an RCAS announcement message (RCASAnnounce) to the CAM (205). The RCAS announcement message may include version information of the CACS and information for the CASS. The information for the CASS is information for the CAM to access the CASS. The information for the CASS may include a CASS identifier (ID), an IP address of the CASS, an IP access type, a listening port number, etc.

When the CAM receives the RCAS announcement message, the CAM may authenticate an RSA digital signature of the RCAS announcement message with an RAS public key of the CASS which the CAM has already possessed. Herein, the RAS public key means a public key encrypted by an encrypted algorithm commonly co-developed by Rivest, Shamir, and Adelman. When the CAM succeeds in authenticating the RCAS announcement message, the CAM analyzes and stores the contents of the RCAS announcement message. In this case, when it is judged that a version of the CACS which the CAM possesses at present is low, the keying & registration phase is performed.

Meanwhile, the CASS may transmit the RCAS renewal message (RCASRenewal) to the CAM when a download timing needs to be distributed so that CACS downloading by the CAMs is not concentrated at one timing or key renewal is requested to the CAM or purchase information of charged contents is requested (210). The RCAS renewal message may include information of a CACS image download time, a key upgrade request, a purchase information request, etc. The CAM may authenticate the RSA digital signature of the RCAS renewal message with the RSA public key of the CASS similarly as the RCAS announcement message. The CAM analyzes the RCAS renewal message when the CAM succeeds in authenticating the RCAS renewal message. In this case, if the information of the CACS image download timing is included in the RCAS renewal message, the CAM may attempt to download the CACS image after waiting up to the download timing indicated by the RCAS renewal message in spite of entering the CACS renewal phase afterwards. Further, if the key upgrade request information is included in the RCAS renewal message, the CAM may immediately perform the keying & registration procedure. Further, if the purchase information request information is included in the RCAS renewal message, the CAM may transmit to the CAS purchase information of charged contents which have been purchased up to now. Herein, the RCAS announcement message and the RCAS renewal message may be transmitted while being not encrypted.

The keying & registration phase are used to request an encryption key for the CACS image, a message encryption key, and initial vectors (IVs) associated therewith to the headend (the CASS and the CA). In the keying & registration phase, the CAM transmits to the CASS a key registration request message (KeyRegRequest) including a session ID, a key pairing ID, and a public key certificate of the CAM as illustrated in FIG. 3 (215). When the CASS receives the key registration request message, the CASS verifies validity for the public key certificate of the CAM included in the key request message through certificate chains. If the public key certificate of the CAM is valid, the CASS authenticates the key registration request message with a digital signature scheme. If the authentication of the key registration request message is succeeded, a key registration request message including the session identifier, the key pairing identifier, the CAM identifier, a CAM hardware (HW) version, a CAM software (SW) version, and the public key certificate is transmitted to the AC (220). However, when the authentication of the key registration request message is failed, an authentication failure message may be transmitted to the CAM and the RCAS network protocol may be ended.

When the AC receives the key registration request message from the CASS, the AC registers the CAM identifier, and generates (derives) an authorization key (AK), encryption keys associated with the RCAS network protocol, and initial vectors (IVs) (225). Herein, the encryption keys associated with the RCAS network protocol and the initial vectors may include an ICCIEK, an initial vector for the ICCIEK, a CCCIEK, an IV for the CCCIEK, an MEK, an IV for the MEK, a message authorization key (MAK), an IV for the MAK, and a key pairing key (KPK).

The AK may be generated by a scheme illustrated in Equation 1 given below.

[Equation 1]

AK=Truncate(PRF(SHA-1(AK_PAD|CAM_ID|Session_ID|NONCE_CAM|HW_Version|SW_Version)),128)

Herein, AK_PAD as a padding value of secure hash algorithm-1 (SHA-1) has a 512 bit string value in which a 0xA3 value is repeated at 63 times. A pseudo random number generation function (PRF) represents a function to generate a predetermined random number.

The ICCIEK may be generated by a scheme illustrated in Equation 2 given below.

[Equation 2]

ICCIEK=Truncate(SHA-1(ICCIEK_PAD|AK),128)

Herein, ICCIEK_PAD as a padding value of SHA-1 has a 512 bit string value in which a 0xA6 value is repeated at 63 times.

The CCCIEK may be generated by a scheme illustrated in Equation 3 given below.

[Equation 3]

CCCIEK=SHA-1(CCCIEK_PAD|AK),128)

Herein, CCCIEK_PAD as a padding value of SHA-1 has a 512 bit string value in which a 0xA6 value is repeated at 63 times.

The MEK may be generated by a scheme illustrated in Equation 4 given below.

[Equation 4]

MEK=SHA-1(MEK_PAD|AK),128)

Herein, MEK_PAD as a padding value of SHA-1 has a 512 bit string value in which a 0x3A value is repeated at 63 times.

The MAK may be generated by a scheme illustrated in Equation 5 given below.

[Equation 5]

MAK=SHA-1(MAK_PAD|AK),128)

Herein, MAK PAD as a padding value of SHA-1 has a 512 bit string value in which a 0x6A value is repeated at 63 times.

The KPK may be generated by a scheme illustrated in Equation 6 given below.

[Equation 6]

KPK=SHA-1(KPK_PAD|AK),160)

Herein, KPK_PAD as a padding value of SHA-1 has a 512 bit string value in which a 0xCA value is repeated at 63 times.

When the aforementioned AK, ICCIEK, CCCIEK, MEK, MAK, and KPK are generated, the AC transfers to the CASS a key registration response message (KeyRegReponse) including the session ID and the AK as illustrated in FIG. 4 (230) and the CSS transfers the AK to the CAM by transmitting the key registration response message to the CAM (235). Herein, the AK may be encrypted with the public key of the CAM.

The CAM that receives the key registration response message authenticates the digital signature of the received key registration response message and when the authentication of the key registration response message is succeeded, the CAM decodes the key registration response message by using the private key of the CAM. In addition, the CAM generates (derives) an ICCIEK, an IV for the ICCIEK, a CCCIEK, an IV for the CCCIEK, an MEK, an IV for the MEK, an MAK, an IV for the MAK, and a KPK based on the AK among decoded values by using the method of Equations 2 to 6 (240).

In the CACS renewal phase, the CASS transmits to the CAM renewal information (RenewInfo) to permit the CAM to download the CACS image information (245). When the CAM receives the renewal information, the CAM performs an operation of authenticating and decrypting the renewal information. In addition, the CAM downloads the CACS image information from a server storing the CACS image information. The CACS image information is encrypted with the ICCIEK and the CCCIEK, and as a result, the CAM decodes the CACS image information by using the ICCIEK and the CCCIEK. When the CACS image information is successfully decoded, the CAM transmits a renewal confirmation message (RenewConfirm) to the CASS (250). In this case, the CASS may authenticate the renewal information and the renewal confirmation message through the SHA-1 scheme by using the MAK generated through Equation 5. Besides, when encryption and message authentication for other all messages including a log message, and the like are used, the encryption and the message authentication may be performed through the MEK and the MAK.

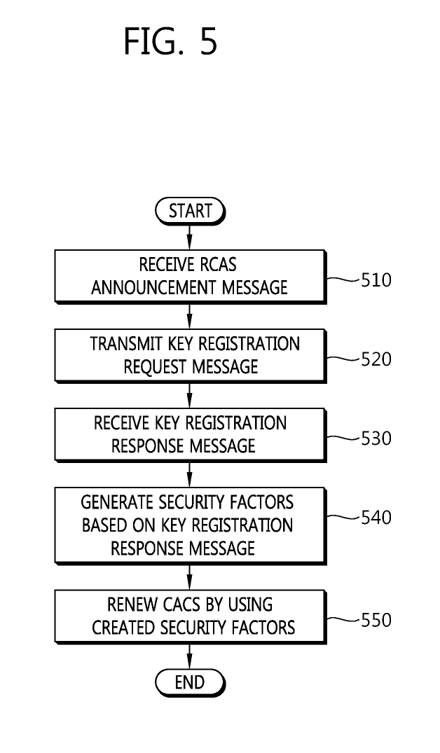

FIG. 5 is a flowchart illustrating an operation of a digital cable broadcast receiver according to an embodiment of the present invention. Hereinafter, a method for the digital cable broadcast receiver to renew the CACS according to the present invention will be described with reference to FIG. 5.

The digital cable broadcast receiver may receive from the headend (for example, the CASS) an RCAS announcement message for announcing that renewal of the CACS is required by using the CAM (510). Herein, the RCAS announcement message may include version information of the CACS and information for the headend. Meanwhile, the digital cable broadcast receiver may receive an RCAS renewal message including information of a download timing of the CACS from the headend as necessary. The RCAS announcement message and the RCAS renewal message may be authenticated by an RAS public key of the CASS prestored in the digital cable broadcast receiver.

The digital cable broadcast receiver transmits to the headend an authorization key (AK) for renewing the CACS and a key registration request message for requesting registration of the CAM when the RCAS announcement message is authenticated (520). Herein, the key registration request message may include a session ID, a key pairing ID, and a public key certificate of the CAM as illustrated in FIG. 3.

When the headend receives the key registration request message, the headend generates an authorization key based on the session ID and a CAM identifier included in the key registration request message by using Equation 1 while registering the CAM identifier included in the key registration request message. In addition, security factors may be generated with the generated authorization key through Equations 2 to 6.

When the CAM of the digital cable broadcast receiver receives a key registration response message including the session ID and the authorization key (530), the CAM generates a security factor based on the received key registration response message (540). As one example, the CAM of the digital cable broadcast receiver may derive the authorization key by using decoding the key registration response message by using a private key of the CAM and generate security factors including an ICCIEK, an IV for the ICCIEK, a CCCIEK, an IV for the CCCIEK, an MEK, an IV for the MEK, an MAK, an IV for the MAK, a KPK, and the like based on the derived authorization key by using Equations 2 to 6. The CAM of the digital cable broadcast receiver may renew the CACS by using the generated security factors (550).

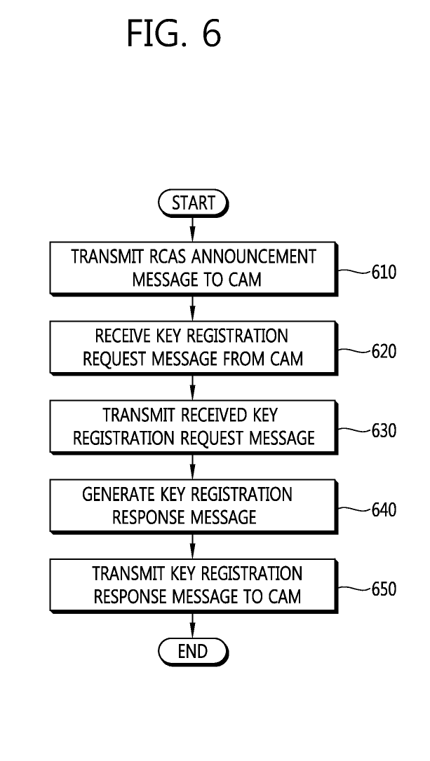

FIG. 6 is a flowchart illustrating an operation of a headend according to an embodiment of the present invention. Hereinafter, a method for the headend to renew the CACS according to the present invention will be described with reference to FIG. 6.

The headend transmits an RCAS announcement message for announcing that the renewal of the CACS is required to the digital cable broadcast receiver including the CAM when the renewal of the CACS of the CAM is required (610). The RCAS announcement message may include version information of the CACS and information for the headend.

Meanwhile, an RCAS renewal message may be transmitted to the digital cable broadcast receiver, which includes at least one of information for a download timing of the CACS, key renewal request information, and purchase information request information when a download timing needs to be distributed so that CACS downloading by the CAMs is not concentrated at one timing or key renewal is requested to the CAM or purchase information of charged contents is requested. The RCAS announcement message and the RCAS renewal message may be authenticated by an RAS public key of the CASS prestored in the digital cable broadcast receiver.

Meanwhile, when the CASS of the headend receives a key registration request message for requesting an authorization key for renewing the CACS from the digital cable broadcast receiver (620), the CASS transmits the received key registration request message to the CA of the headend (630). The CA generates the authorization key and the security factors while registering the corresponding CAM based on the key registration request message. Herein, the key registration request message may include a session ID, a key pairing ID, and a public key certificate of the CAM. Further, the security factors may include at least one of including an ICCIEK, an IV for the ICCIEK, a CCCIEK, an IV for the CCCIEK, an MEK, an IV for the MEK, an MAK, an IV for the MAK, and a KPK.

Thereafter, the CA of the headend generates a key registration response message including the session ID and the authorization key (640) and transmits the generated key registration response message to the CASS to transfer the authorization key to the CAM of the digital cable broadcast receiver (650). Thereafter, the headend transmits renewal information for downloading the CACS to the CAM to renew the CACS of the CAM.

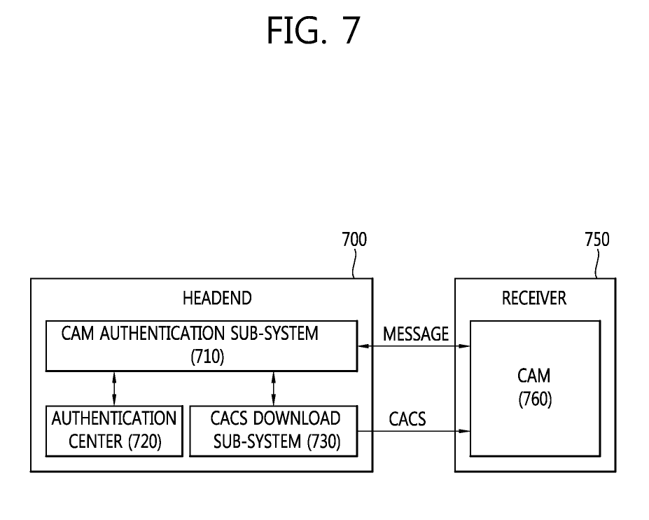

FIG. 7 is a block diagram illustrating a renewable conditional access system according to an embodiment of the present invention.

Referring to FIG. 7, the renewable conditional access system according to the present invention includes a headend 700 and a receiver 750.

The headend 700 may include a CAM authentication sub-system 710, an authentication center 720, and a CACS download sub-system 730.

The CAM authentication sub-system 710 transmits to a CAM 760 included in the digital cable broadcast receiver 750 an RCAS announcement message for announcing that renewal of the CACS is required, receives a key registration request message for requesting an authorization key for renewing the CACS from the CAM 760, and transmits the key registration request message to the authentication center 720 when the validity of the key registration request message is verified and the authentication of the key registration request message is succeeded.

When the authentication center 720 receives the key registration request message from the CAM authentication sub-system 710, the authentication center 720 generates the authorization key and the security factors and transmits a key registration response message including the authorization key to the CAM authentication sub-system 710 so as to transmit the authorization key to the CAM 760 while registering the CAM 760 based on the key registration request key.

The CACS download sub-system 730 transmits a source CACS to the CAM 760 so as for the CAM 760 to renew the CACS.

Meanwhile, the digital cable broadcast receiver 750 includes at least one memory, at least one processor, and the CAM 760. The digital cable broadcast receiver 750 according to the present invention may be a set-top box.

The CAM 760 receives from the headend 700 an RCAS announcement message for announcing that renewal of the CACS is required through a cable network and transmits a key registration request message for requesting an authorization key for renewing the CACS to the headend 700 when the RCAS announcement message is authenticated. In addition, when the CAM 760 receives a key registration response message including the authorization key, the CAM 760 generates security factors based on the authorization key and renews the CACS by using the security factors. In this case, the CAM 760 may authenticate the RCAS announcement message by using an RAS public key which is prestored in the digital cable broadcast receiver 750. The RCAS announcement message may include version information of the CACS and information for the headend 700 and the key registration request message may include a session ID, a key pairing ID, and a public key certificate of the CAM.

The CAM 760 may derive the authorization key by using decoding the key registration response message by using a private key of the CAM and generate an ICCIEK, an IV for the ICCIEK, a CCCIEK, an IV for the CCCIEK, an MEK, an IV for the MEK, an MAK, an IV for the MAK, and a KPK based on the authorization key and the session ID by using Equations 2 to 6.

While some embodiments of the present invention have been described with reference to the accompanying drawings, those skilled in the art may change, modify, and substitute the present invention in various ways without departing from the essential characteristic of the present invention. Accordingly, the various embodiments disclosed herein are not intended to limit the technical spirit but describe with the true scope and spirit being indicated by the following claims. The scope of the present invention may be interpreted by the appended claims and all the technical spirits in the equivalent range thereto are intended to be embraced by the claims of the present invention.

What is claimed is:

1. A method for renewing conditional access client software (CACS) by a conditional access module (CAM) included in a digital cable broadcast receiver in a renewable conditional access system (RCAS), the method comprising:
receiving an RCAS announcement message for announcing that renewal of the CACS is required from a headend;
transmitting to the headend a key registration request message for requesting an authorization key for renewing the CACS when the RCAS announcement message is authenticated;
receiving a key registration response message including the authorization key from the headend; and
generating security factors based on the authorization key and renewing the CACS by using the security factors.

2. The method of claim 1, further comprising after the receiving of the RCAS announcement message, receiving from the headend an RCAS renewal message including information of a download timing of the CACS.

3. The method of claim 2, wherein the RCAS announcement message and the RCAS renewal message are authenticated by an RAS public key prestored in the digital cable broadcast receiver.

4. The method of claim 1, wherein the RCAS announcement message may include version information of the CACS and information for the headend.

5. The method of claim 1, wherein the key registration request message includes a session identifier (ID), a key pairing ID, and a public key certificate of the CAM.

6. The method of claim 1, wherein the authorization key is derived by decoding the key registration response message by using a private key of the CAM.

7. The method of claim 1, wherein the security factors include at least one of an individual CAM client image encryption key (ICCIEK), an initial vector for the ICCIEK, a common CAM client image encryption key (CCCIEK), an initial vector for the CCCIEK, a message encryption key (MEK), an initial vector for the MEK, a message authorization key (MAK), an initial vector for the MAK, and a key pairing key (KEK).

8. A method for renewing conditional access client software (CACS) by a headend in a renewable conditional access system (RCAS), the method comprising:
transmitting an RCAS announcement message for announcing that renewal of the CACS is required to a conditional access module (CAM) included in a digital cable broadcast receiver;
receiving a key registration request message for requesting an authorization key for renewing the CACS from the digital cable broadcast receiver;
generating the authorization key and security factors based on the key registration request message; and
transmitting to the CAM a key registration response message including the authorization key and transmitting renewal information for downloading the CACS.

9. The method of claim 8, further comprising after the transmitting of the RCAS announcement message, transmitting to the CAM an RCAS renewal message including information of a download timing of the CACS.

10. The method of claim 9, wherein the RCAS announcement message and the RCAS renewal message are authenticated by an RAS public key prestored in the digital cable broadcast receiver.

11. The method of claim 8, wherein the RCAS announcement message may include version information of the CACS and information for the headend.

12. The method of claim 8, wherein the key registration request message includes a session identifier (ID), a key pairing ID, and a public key certificate of the CAM.

13. The method of claim 8, wherein the security factors include at least one of an individual CAM client image encryption key (ICCIEK), an initial vector for the ICCIEK, a common CAM client image encryption key (CCCIEK), an initial vector for the CCCIEK, a message encryption key (MEK), an initial vector for the MEK, a message authorization key (MAK), an initial vector for the MAK, and a key pairing key (KEK).

14. A digital cable broadcast receiver of a renewable conditional access system (RCAS), comprising:
at least one memory;
at least one processor; and
a conditional access module (CAM),
wherein the conditional access module
receives an RCAS announcement message for announcing that renewal of conditional access client software (CACS) is required from a headend,
transmits to the headend a key registration request message for requesting an authorization key for renewing the CACS when the RCAS announcement message is authenticated,
receives a key registration response message including the authorization key from the headend, and
generates security factors based on the authorization key and renewing the CACS by using the security factors.

15. The receiver of claim 14, wherein the conditional access module authenticates the RCAS announcement message by using an RAS public key prestored in the digital cable broadcast receiver.

16. The receiver of claim 14, wherein the RCAS announcement message may include version information of the CACS and information for the headend.

17. The receiver of claim 14, wherein the key registration request message includes a session identifier (ID), a key pairing ID, and a public key certificate of the CAM.

18. The receiver of claim 14, wherein the conditional access module derives the authorization key by decoding the key registration response message by using a private key of the CAM.

19. The receiver of claim 14, wherein the security factors include at least one of an individual CAM client image encryption key (ICCIEK), an initial vector for the ICCIEK, a common CAM client image encryption key (CCCIEK), an initial vector for the CCCIEK, a message encryption key (MEK), an initial vector for the MEK, a message authorization key (MAK), an initial vector for the MAK, and a key pairing key (KEK).
